(19) United States
(12) Patent Application Publication
(10) Pub. No.: US 2004/0006487 A1
(43) Pub. Date: Jan. 8, 2004

(54) Centralised system and method for dispensing services to automatic sales terminals

(76) Inventor: Xavier Tari, Pont de Claix (FR)

Correspondence Address: WOLF GREENFIELD & SACKS, PC, FEDERAL RESERVE PLAZA, 600 ATLANTIC AVENUE, BOSTON, MA, 02210-2211, US

(21) Appl. No.: 10/343,559

(22) PCT Filed: Jul. 27, 2001
(86) PCT No.: PCT/FR01/02475

(30) Foreign Application Priority Data
Aug. 2, 2000 (FR) 00 10210

(51) Int. Cl. G06F 17/60

(52) U.S. Cl. 705/1

(57) ABSTRACT

The invention concerns a service dispensing system comprising a management centre (4) connected to at least an automatic dispensing terminal for delivering a printed support which constitutes access means to a service. The terminal comprises printing means for locally printing on the support (70) a visual element (72) enabling to identify by its aspect the service and/or service supplier. The visual element can be produced from a graphic charter of the supplier, loaded in the form of printing data in said terminal (4), to produce locally said print of the visual element (72). It is then possible to produce said visual locally with the same aspect as a pre-printed card for a given service.

The present invention relates to the field of services sold through automatic dispensing machines that provide a support enabling access to a selected service, in return for payment

The term “service” should be understood in its broadest sense, for example covering the use of a telephone network (mobile or switched telephone network), the sale of tickets (for shows, fairs, cultural and sports events, etc.), Internet access, purchase of vouchers, gift vouchers, restaurant tickets, etc.

Patent documents U.S. Pat. No. 5,868,236 and U.S. Pat. No. 5,696,908 describe automatic service access dispensers, particularly for long distance telephony, in which a personal access code usually called a PIN (“Personal Identification Number”) code is acquired. This code is printed on a sheet and is issued to the purchaser after making a transaction during which a prepaid amount of telephone calls was selected and validated, for example using a bank card reader. The PIN code then corresponds to an anonymous virtual account number enabling use of this prepayment. The user types the PIN code thus acquired using the telephone keys at the beginning of the call to identify the number, and the line is then opened for dialling according using the conventional call procedure. Access to the service is interrupted when the prepaid amount is exhausted. Note that all that maters is the information printed on the sheet, namely the PIN code. The support on which this information is printed, for example the abovementioned sheet, is thus of the “non technical” type.

There are also automatic dispensers that offer a similar service, but using smart cards. In this case, the user acquires a card during the transaction to access a telephone network through adapted terminals equipped with a card reader. Cards contain data stored in electronic memory that inform the operator about the remaining prepaid amount and other related information. In this case, the support itself is a technical element that is essential for use of the service. Patent document WO-A-97 22919 describes an example of a dispenser for purchasing a telephone smart card containing a value established during the transaction. The dispensing terminal concerned is equipped with a chip encoder capable of writing a prepayment value selected by the user, with the chip being initially empty and not containing any prepayment.

Patent document U.S. Pat. No. 5,513,117 also describes a dispenser of gift cards and gifts, including prepaid telephone cards, in which the purchaser can print a pattern or a message of his choice on the purchased product.

Although these various dispensers facilitate access to services, it is quite clear that in their present state, they are technically incapable of supporting the increasing commercial demand for services in these fields.

In the light of the above, the present invention proposes a system for dispensing services including a management centre connected to at least one automatic dispensing terminal that will issue a printed support that acts as an access means to a service, characterised in that the automatic dispensing terminal comprises printing means for producing a local printout on the support to identify the service and/or the service provider, through its appearance.

With this layout, a complete standalone support can be made, for example a non technical card or a smart card, with an appearance that satisfies the specification of the service provider operator in terms of graphics and other printed contents.

Advantageously, the visual element is produced from a supplier's graphic charter, loaded into the said terminal in the form of print data, so that the said printout of the visual element can be made locally.

With this layout the visual element can be created locally and have the same appearance as a pre-printed support for a given service, for example like the visual element dispensed through other channels (shops, premium services, etc.).

The system can then operate with several independent operators and/or can supply several different services, all identifiable by a specific card visual element without it being necessary to increase the number of support stocks in each terminal. This enables versatility with no practical limit on the different operators or service ranges provided. A single card loader per terminal can satisfy all needs in terms of support stock management, so that relatively simple and well known mechanisms can be used, while making it easy to adapt existing dispensing terminals.

With this approach, a change to a visual element can be made immediately, or new visual elements corresponding to newly available services can be added without the need to do anything to make a physical change to the stock of supports in the terminals. In one preferred embodiment, the print data for the visual elements are downloaded in advance onto each terminal from the management centre, for example during an update cycle.

In one advantageous embodiment, the printing means are activated to print the visual element during a transaction.

The visual element is usually the distinctive part of the card that is invariable for a given service type and a given supplier. It may include at least one of the following elements expressed distinctively:

the banner of the service supplier (76) or the service,

a logotype (78,80), and

a background colour (82) that may be monochrome or polychrome, with or without a pattern.

The graphic data for each visual element that might be printed may be stored in the automatic dispensing terminal in advance. In this case, these graphic data may be downloaded into the dispensing terminal from the management centre during update cycles.

As a variant, graphic data for the visual element to be printed during a transaction may be transmitted to the automatic dispensing terminal from the management centre during this transaction.

Preferably, printing means are provided in the automatic dispensing terminal to print variable data on the support during the transaction, including at least one of the following data:

a confidential and individual code (PIN code) providing access to the service purchased during the transaction,

the credit amount acquired for the purchased service,

the serial number of the support,

the expiration date of the service assigned to the support, and

the method of use specific to the purchased service.

The confidential and individual code is preferably located under a part of the support that will be covered with an opaque layer that can be removed by scratching.

Each terminal may also comprise print means to print at least one advert on the support and/or to display it on a screen.

These data related to printing adverts may be stored in the dispensing terminal and downloaded into the dispensing terminal from the management centre during update cycles.

However, it is also possible for the print data necessary for printing an advert during a transaction to be transmitted to the automatic dispensing terminal from the management centre at the time of this transaction.

To benefit from the resulting versatility, the system is advantageously functionally connected through the management centre to several independent service provider operators, so that a set of different services of these operators can be provided, so that they can be chosen and sold through the automatic dispensing terminals.

Preferably, the support is stored in the automatic dispensing terminal in blank form or as a preprinted form with elements that are valid for all services sold through the terminal, such that before they are printed, the supports can be used for any of the available services.

Each terminal may also comprise means of printing general conditions of sale for the different available services.

In one embodiment, the automatic dispensing terminal may comprise a blank support loader for each type of support that could be delivered: non technical card, card with magnetic strip, smart card, etc.

Advantageously, the confidential and individual code is sent to the automatic dispensing terminal through the management centre at the time of the transaction. It may be sent to the management centre by the service provider operator concerned during a downloading step during system maintenance cycles.

In the preferred embodiments, each automatic dispensing terminal comprises a screen that interactively displays information about progress with the transaction in relation to a management unit and a local database.

The system may also be designed so that a previously opened service access account can be reloaded.

It can be used to enter and acknowledge an exact prepaid amount to be assigned to an ordered service, this exact amount being printed on the support.

Preferably, the system comprises encryption and decryption means for confidential data exchanged between the management centre and each automatic dispensing terminal.

It can be configured so that several services of the same type or different types can be purchased in a single transaction, the purchases possibly being accumulated in memory with acquisitions so far being displayed, each service thus purchased being followed by printing a specific support.

The system may comprise means of acquisition of a customer file containing accumulated information about at least one of the following:

the physical location of the automatic dispensing terminal being used,

the choice of purchased service(s),

amounts spent, and

data provided by the customer through an automatic dispensing terminal during queries made during a transaction, so as to produce an up to date profile of the customer, the file being accessible at the management centre.

With this layout adverts can be displayed on the support and/or on the screen of the automatic dispensing terminal as a function of the profile drawn up for the customer using the terminal.

In one preferred embodiment, the system also manages a customer loyalty program to assign loyalty points, rebates, gifts, etc. as a function of a loyalty account kept open and maintained in the management centre. Loyalty may also be controlled within the commercial framework of a service provider operator, or within a global framework based on sales from a set of services provided by different independent service provider operators managed by the management centre and the automatic dispensing terminals.

The system can print a customised message on the support.

Preferably, it also comprises means of displaying comparative price rate information and/or general conditions of sale for the different available services, to a customer.

This comparative information may be stored in a local database in each automatic dispensing terminal by downloading from the management centre.

The automatic dispensing terminal may also comprise an audio interface in which there is a microphone and a loudspeaker, so that a customer can get in touch with a customer service.

Interactive display means may also be provided to display a welcome page controlled directly from the management centre, so that the contents of the menu can be modified from a remote location.

If necessary, the automatic dispensing terminal may include means of writing data, so that electronic data about a prepayment can be written into a smart card during a transaction to purchase a card or to reload a card.

The system can operate with a support in the form of a smart card, and particularly a chip card and/or a magnetic track card, a prepayment being memorised on the card at the time that the data are written.

The system may also operate with a non technical card as the support.

At least one of the available services may relate to the sale of cards for use in telephony on the fixed or a mobile network.

At least some automatic dispensing terminals may also be operational as access terminals providing access for the general public to the Internet in return for prepayment, the terminal using a display screen and a keyboard, and a modem connected to the terminal and to an Internet access provider through the management centre.

The invention also relates to an automatic dispensing terminal specifically adapted to the system, characterised in that it comprises printing means to create a local printout of a visual element on the support so that the service and/or the service provider can be identified through the appearance of the visual element.

The invention also relates to a process for dispensing services based on a management centre connected to at least one automatic dispensing terminal that will output a printed support that forms a means of accessing a service, charcterised in that a visual element is printed on the support in the automatic dispenser, so that the service provider can be identified through the appearance of this visual element.

Optional aspects of the invention related to the system are applicable mutatis mutandis to this process.

Other aspects and advantages of the invention will become clearer after reading the preferred embodiments, given purely as non-limitative examples with reference to the drawings showing the organization of a network of dispensing terminals for dispensing services in conformance with the present invention;

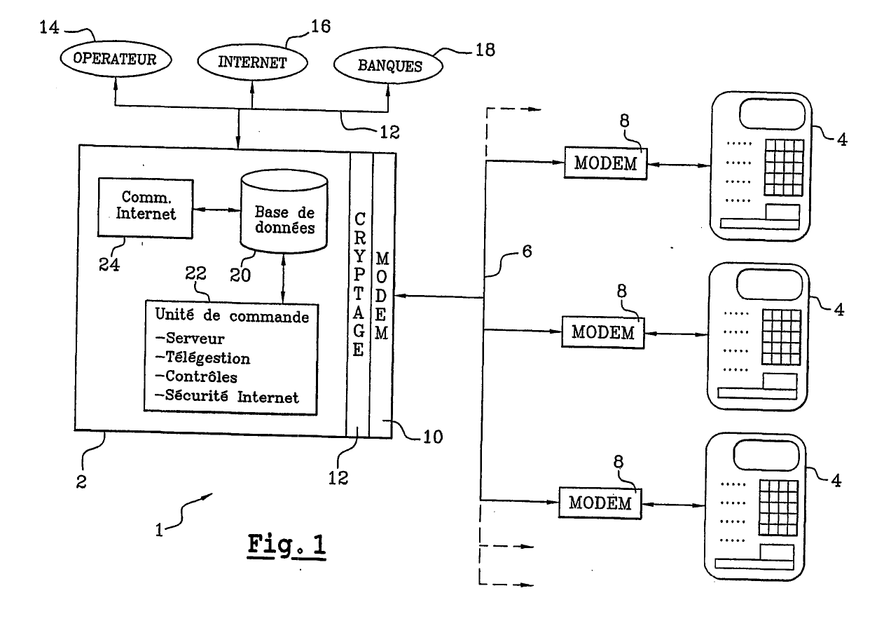

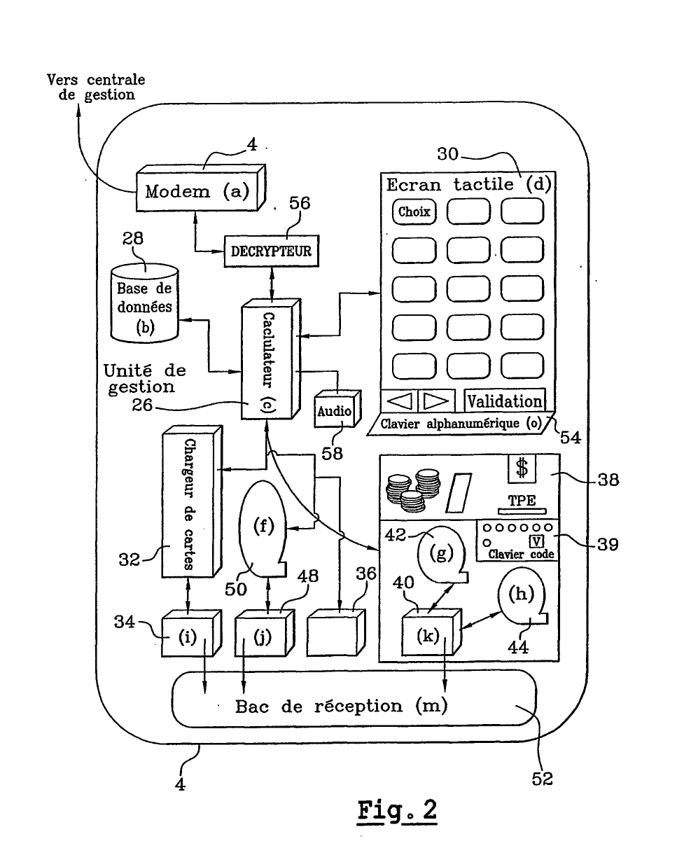

FIG. 2 is a block diagram of functional elements of a dispensing terminal shown in FIG. 1;

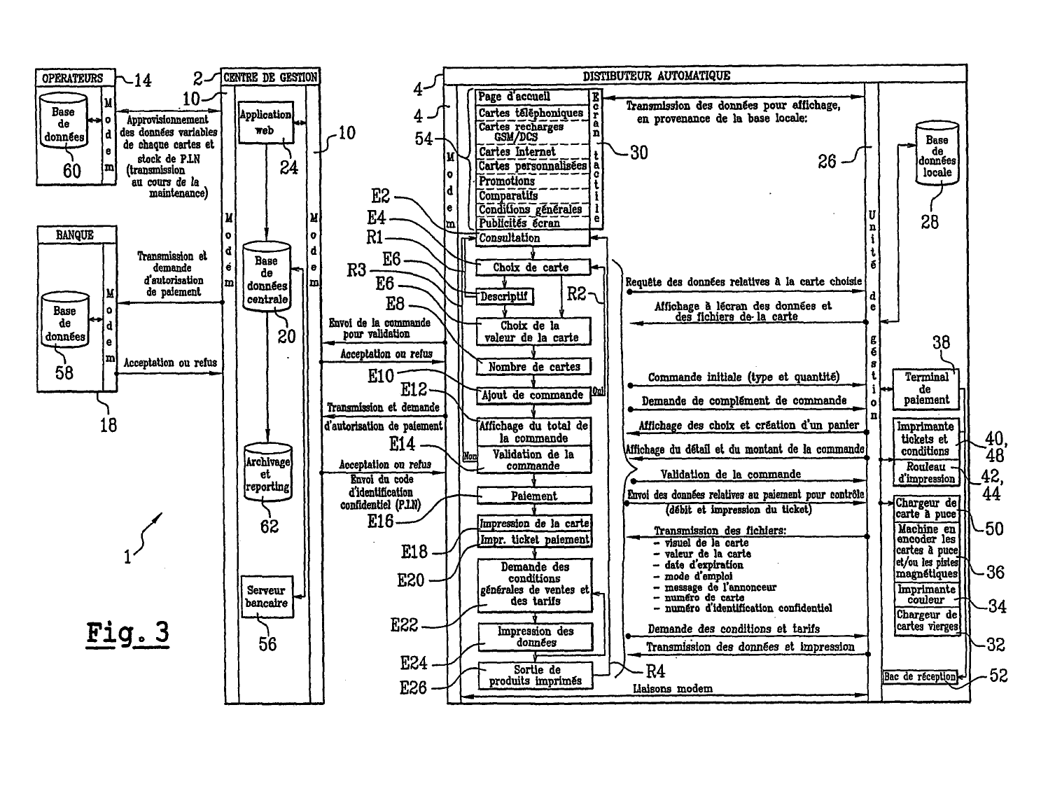

FIG. 3 is a flow chart showing the different steps involved in purchasing a prepaid card on the network in FIG. 1, also showing information exchanges made during these steps;

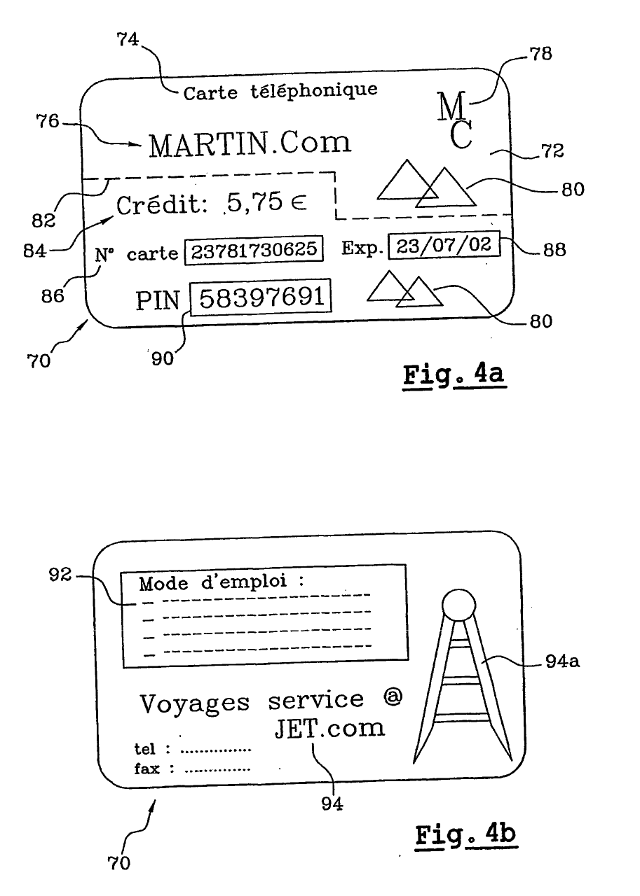

FIGS. 4a and 4b show the front and back sides respectively of a prepaid card obtained following the transaction shown diagrammatically in FIG. 3;

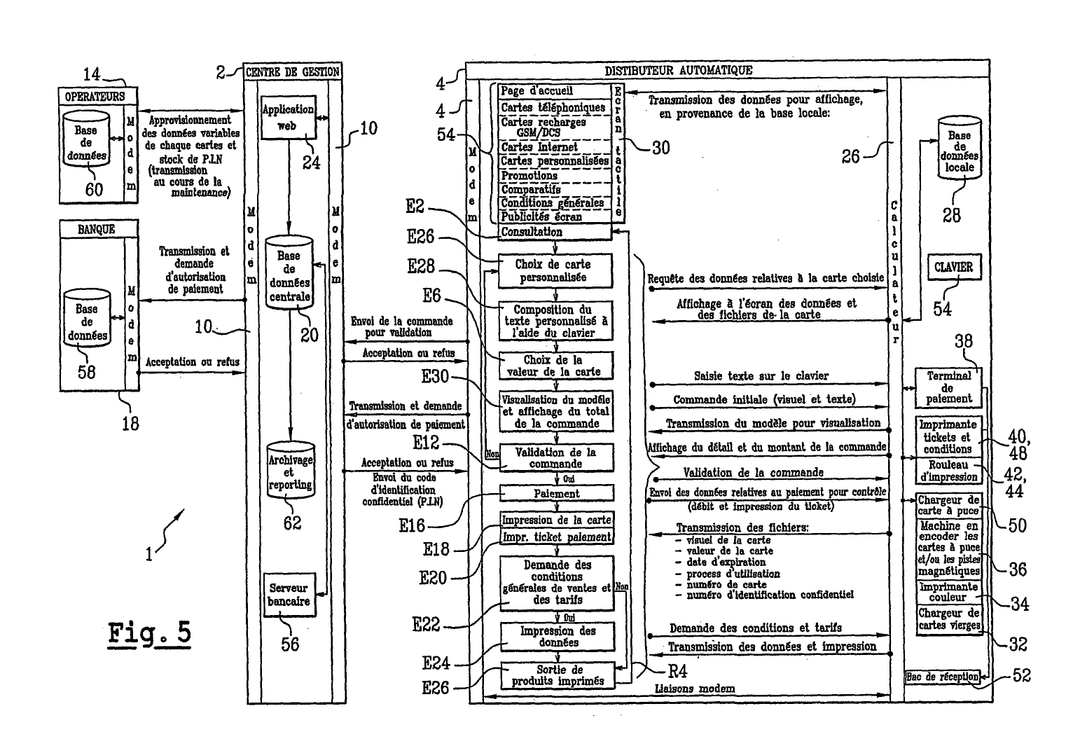

FIG. 5 is a flow chart similar to that in FIG. 3, showing the case of a purchase of a customised prepaid card; and

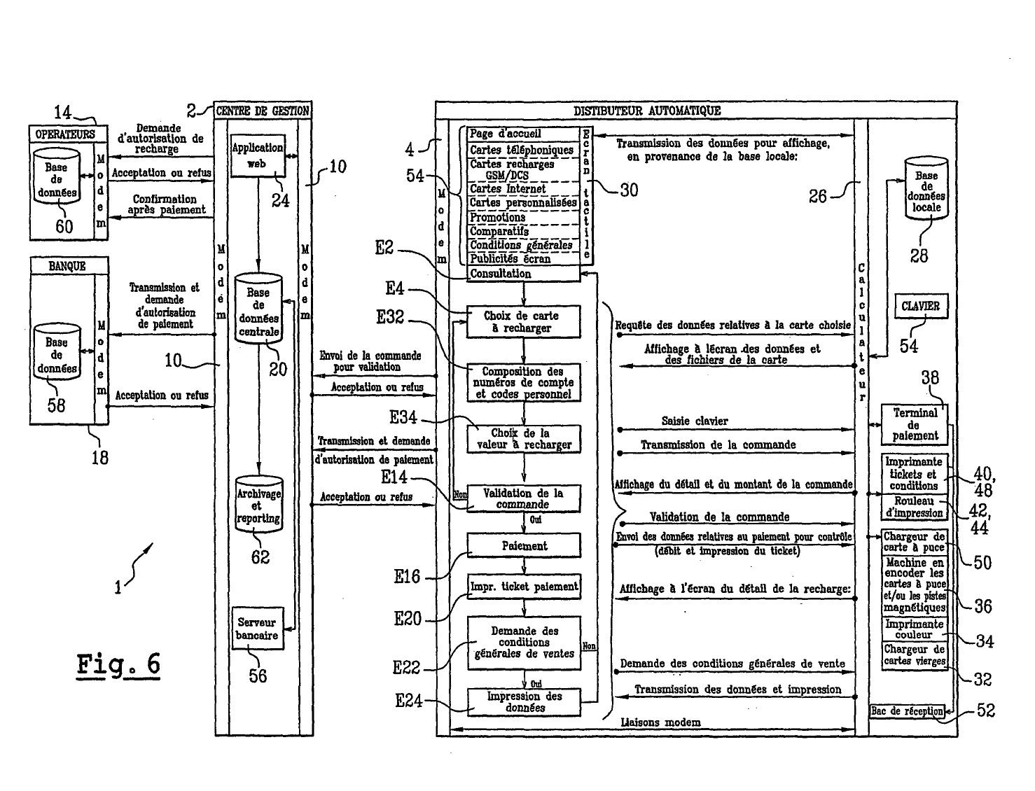

FIG. 6 is a flow chart similar to that in FIG. 3, presenting the case of a reload of a prepaid card.

Thus as shown in FIG. 1, a network 1 of service dispensers according to the present invention comprises a management unit 2 on which a set of automatic dispensing terminals 4 depend. These automatic dispensing terminals are connected to the management centre 2 through a two-directional wired telephone or radio link. However, other types of two-directional links could be considered (specific communication network, computer buses, etc.). Since the link has to carry an exchange of digital data, each terminal 4 is provided with a modem 8 (shown separately in this case for reasons of clarity). Similarly, a modem 10 is also provided in the management centre 2.

Data sent by the management centre 2 are partially confidential, consequently an encryption and decryption stage 12 is provided on the input side of the modem 10, according to a method known per se. Each terminal 4 then comprises corresponding encryption and decryption means (shown in FIG. 2).

The management centre 2 is also connected through a telephone network 12 (public or private) to an external environment, and particularly to:

different service provider operators 14, providing services sold through the terminals 4, these operators possibly being independent of each other, or even competitive with each other,

the Internet network 16,

and the banking world 18.

Information acquired from this external environment that needs to be saved is stored in a central database 20 in the management centre 2. The main functions of the management centre 2 for sales of services are combined in a control unit 22, that acts as server and performs remote management, control and guarantees security on the Internet for the terminals 4, as will become clear later.

Special communication features on the Internet network are provided by an Internet communication module.

Other more detailed functional aspects of the management centre 2 will be explained in their context in the rest of the description.

In order to accomplish its various tasks, the management centre 2 uses one or several communicating computers which, together with various peripheral devices, form a hardware means that can be made by a person skilled in the field of remote management of remote interactive terminals. Therefore, the details of the construction of the management centre 2 will not be described herein for reasons of conciseness.

FIG. 2 is a block diagram showing the main elements of an automatic dispensing terminal 4. The terminal itself includes a management unit 26 that controls all the various elements. These terminal elements comprise:

the above-mentioned modem 4 that forms the interface with the management centre 2 to supply variable data to be transmitted to the purchaser, to reload cards or tickets providing access to the services, and to make a technical check of the terminals and to transmit data input on the terminal by the customer;

a local database 28 that in particular contains all information necessary for the terminal to carry out some functions internally,

an interactive display screen with selection using a finger, for example a touch screen 30. Among other features, this screen can be used to visit a service provider's commercial site so that consumers can purchase or recharge prepaid supports such as cards. This screen 30 displays up to date information (advertising, comparisons, promotions, price rates, etc.). It also displays data and can be used for browsing on the Internet. Similarly, a user can use this terminal to access Internet, or similarly to visit the commercial site, or even to perform the commercial transaction through which a card will be issued on which all distinctive visual elements related to the service and the supplier will be printed locally by the terminal;

a card loader 32, the cards forming the access support to a purchased service. The loader supplies blank cards (plastic or cardboard) that may be non technical cards or chip cards or magnetic strip cards. The card loader may be supplemented or replaced by an automatic pre-cut paper roll feed, each sheet forming a non technical type support for access to a service. Several loaders may be provided to increase versatility in terms of support types (non technical cards, chip cards, etc.). In one typical embodiment) the terminal may comprise three blank card loaders, one used to store non technical cards, one to store “open” chip cards ready for programming or loaded locally depending on the purchased service, and one to store “open” magnetic strip cards ready for programming or loaded locally depending on the purchased service;

a colour printer 34 that prints variable data and graphics to transform a blank card or other support with no printing on it, into a printed card as it will appear when on sale depending on the service provider concerned, in other words provided with a PIN type access code, a visual element representing the service provider's trademark or banner, a method of use, and possibly an advert by an advertiser who would like to carry a message through a service card. In this embodiment, the printer operates in front-back mode so that distinctive visual elements can be printed on the two sides of the card to be issued. The printer can operate with card supports on which the PIN code is initially concealed behind an opaque layer which can be removed by scratching, so as to keep this code confidential until the required moment. A device is then provided to deposit the opaque layer on the printed area that operates after the code has been printed. This option is particularly useful for purchases made on behalf of third parties, for example when purchasing several cards in the same transaction, not all of which will be used by the purchaser,

an encoder for electronic chip cards or magnetic strip cards 36, capable of writing data in a memory area on the card about a quantity and/or type of purchased service, for example a number of units that can be used in the case of a telephone card. In the case of a chip card, the encoder comprises an interface with a card with or without contacts;

a payment terminal 38 that can accept payment for ordered services, either by bank or other cards, or by cash. Consequently, the payment terminal comprises a card reception slit, a keyboard 39 on which a confidential code is input, a means of communicating data, and possibly a cash dispenser;

a first monochrome printer 40 to print cash tickets, that operates on a first roll 42 that will produce receipts for customers, and on a second roll 44 that is stored internally to save all commercial transactions;

a second monochrome printer 48 to print general conditions of sale related to sold services, this printer being supplied with a paper roll 50;

a reception tray 52 into which all printed supports output by the dispensing terminal (cards, payment tickets, general conditions of sale and price rates) will be delivered;

an alphanumeric keyboard 54, possibly used with a screen pointer device, that operates in association with the touch screen 30, and that in particular is used to:

enter a text for customised orders, for example greeting cards, visiting cards, telephone cards, tickets for shows, etc., this text being printed on the colour printer 34,

input an account number and/or the card number during execution of reloading programs,

enter an account number and/or the card number when executing loyalty programs, and

browse on Internet;

an encryption and decryption module 56 connected to the modem 4 for exchange of encrypted messages with the management centre 2, particularly bank card confidential codes and service access codes; and

an audio interface 58 comprising a microphone and a loudspeaker that enables a connection to a customer service through the management centre 2. The consumer can then get into communication with the management centre 2 to obtain complementary information (price rates, operation, promotions, solutions to usage problems, etc.). This interface may be complemented by a video interface provided with a camera and a special screen (or based on the touch screen 30) to perform videophone functions.

In some operating modes, the above-mentioned colour and monochrome printers 34,40 and 48 may be combined in a common versatile print set.

Note that chip cards, magnetic strip cards or non technical cards can be printed from a blank printing support, to produce an unlimited number of different cards from a common stock of cards contained in the loader 32. It is thus possible to locally make cards with visual elements (logotypes, graphic infill, coloured patterns, etc.) satisfying graphic charters of different service provider operators. In particular, the graphic charter defines the presentation, the colour(s), the characters to be used in the different parts, the patterns, logos, symbols, photos, etc., to be printed, etc. These cards made in this way then all look the same as cards for the same service sold through conventional sales networks (shops, post offices, etc.).

We will now describe a first example of operation of the automatic dispensing system 1 to provide services for the sale of telephone cards with reference to FIG. 3, making use of non technical cards or chip cards, however it will be understood that this system is open so that any type of service or product can be sold provided that access is obtained through a printed support. These products and services may originate from a large number of independent operators active in different fields and/or competitive in the same fields. Typically, the system can manage 100, or even a very much larger number, of services and different products, due to its versatility in terms of the stored supports. Solely as an example, apart from prepaid telephone and Internet cards, the services, products and supports may apply to reload cards for mobile telephones, prepaid cinema cards, loyalty cards, service and subscription cards, transport tickets, travel tickets, sports events, shows, access cards to leisure centres, attraction parks, hotel rooms, etc.

In the initial operating mode, the automatic dispensing terminal 4 displays a welcome message 54 on its touch screen 30 loaded from information stored in the local database 28. This message contains a brief summary of all possible transactions available to the customer in the form of sections, for example:

the choice of different telephone cards operating on the cabled public network or on mobile telephones, with an indication of the name of the supplier (the operator), with his banner in the form of icons,

a choice of Internet access cards, distributed by one or several access suppliers,

a choice of customised cards on which the customer can print a pattern or a message of his choice,

display of ongoing promotions,

comparisons between services,

general conditions of sale, and

adverts.

Some of these sections are interactive so that the customer can define details of his procedure. Thus, by selecting the “comparisons between services” section (by touching the corresponding icon), a comparisons table is opened in which precise comparison criteria can be selected; for example, the cost per minute of communications to a specific country for different operators. This information is stored in the local database 28 and is updated by the management centre 2 during remote maintenance cycles.

All this information is presented in a viewing step E2 that leads to a choice of cards (step E4) made by a selection on the touch screen 30. The local database 28 is then queried to provide data about the chosen card, and these data are then sent to the touch screen 30 under the control of the management unit 26.

In response, the terminal 2 may display a complementary description on the screen, related to the selected card, but which is too specific to be mentioned in the welcome page. The initial choice may be modified after reading this description, consequently it is possible to return to the welcome page 54 (loop back R1).

If this option to return to the welcome page or a complementary description page is not selected, the value of the card can be selected (step E6). In this step, the customer chooses the prepaid communication amount agreed to for the account that will be opened or reloaded through the card. The selection is made in two possible ways; either by displaying an amount among several amounts displayed in corresponding boxes (for example 5, 10, 25 or 40 Euros) on the touch screen 30, or by entering a precise amount on the alphanumeric keyboard. In this respect, note that a prepaid amount can be specifically chosen because the card is made interactively and its support is initially blank so that any amount can be printed in the space set aside for the prepaid or reloaded amount indication.

Once this choice has been made, the terminal displays the required number of cards, this number being selected by designating a corresponding box on the touch screen (step E8).

The terminal then asks if the customer would like to make another purchase (step E10). If he does, the process loops back to step E4 to choose the card, while the purchase of the service specified in the previous steps E4 and E6 is memorised. It is thus possible to order several successive purchases before paying for them all together.

Data about the choice of the card and the number of cards are transmitted to the management unit 26 so that they can be formatted and sent to the central unit 2. In the case of an addition to an order (step E10 and loop back R2), the management unit sets up a routine to request additional information.

When a selected service is fully specified, the terminal creates an “order basket” displayed on the touch screen in the form of a symbol, such as an icon representing an indication of the unit value and the number purchased, and the total amount of the purchases, for each of the purchased cards.

At the end of the selection steps (no order or no more additions of orders in step E10), the terminal displays the total amount of the order (step E12). A message is then displayed prompting the customer to validate the order (step E14).

If validation is refused, the purchase process returns to step E2 to view services (loop back R3). Otherwise, the management unit accepts validation of the order and starts a communication phase with the management centre 2.

The order is then sent to the order unit 22 (FIG. 1) using a predetermined protocol, and the order unit makes the first check to determine whether or not the order can be processed. Since the order has already been approved locally in the terminal 4, this verification applies mainly to specific variables, for example a service interruption at one of the operators 14 that would prevent conclusion of the transaction. After the check, the control unit sends an acceptance or refusal message to the terminal 4.

If the order is accepted, the terminal responds by beginning a payment acknowledgement routine (step E16) that acts jointly with the management centre 2 and the bank server 18.

This routine, known in itself for applications in dispensers, uses an interactive display program that the customer can use to insert his bank card into the slit in the payment terminal 38, input his confidential code, collect input information and the data on the chip or the magnetic track, and transmit this information to the management centre 2 where it will be processed by a bank server 56 in the management centre 2. This information is sent from the management centre to a bank centre 18 for processing payments that returns an acceptance or refusal after querying the database 58. Acceptance or refusal is forwarded to the dispensing terminal 4 through the management centre 2.

If the transaction is accepted, the terminal creates the service access card(s) and prints a payment ticket.

The data to be printed on the blank support originate firstly from the local database 28 and secondly from the central database 20.

In particular, the central database 20 is the source of the PIN (personal identification number) code that will be printed. This code is then sent to the terminal with the order acceptance message.

This layout prevents the need to store PIN codes in the terminal, thus reducing risks of fraudulent attacks.

PIN codes are supplied to the management centre 2 by the various service provider operators during procurement cycles external to the current transaction, using a specific call process. In this way, the management centre is capable of immediately supplying the appropriate PIN code without the need to consult the operator concerned in advance. The various PIN codes are stored in the central database 20 by ranges of numbers. When a code is assigned during a transaction from any terminal on the network it is then recognised as being no longer available and a pointer in the database points to the next PIN code to be used in the next transaction.

However, it is possible to consider a variant in which a PIN code is requested from the operator concerned for each transaction, if it is required that a stock of PIN codes should not be kept in the management centre.

Thus, for each ordered card, the management centre 2 associates a unique PIN code in conformance with the protocol of the service provider operator (number of digits, coding, conformity with predetermined series). The central unit then creates a file specific to each card containing the assigned PIN code, the acknowledged prepayment value (this information being transmitted from the terminal) and possibly other parameters related to the transaction. This file is stored in an archiving memory 62 to enable management internal to the system. It will also be sent in full or partially to the operator 14 so that the operator can know that part of a PIN code that he had previously sent to the central unit has been forwarded to a purchaser, and secondly the prepaid amount assigned to this code. The operator can thus immediately activate the account thus opened with this communication prepayment) to enable calls.

These operations can be carried out at the same time as the PIN code is transmitted to the automatic dispensing terminal 4, or slightly afterwards.

The PIN code is transmitted in encrypted form between the operator 14, the management centre 2 and the dispensing terminal 4.

The PIN code thus received by the terminal 4 is decrypted and processed by the management unit 26 to form a component of the set of print data that will be printed on the blank card. In the example considered, the PIN code forms one data variable (in fact it is one variable, or data variable-data is plural, “one data” isn't very nice) among these print data, in as much as it is specific to each transaction.

FIGS. 4a and 4b show the front and back faces respectively of an example of an initially blank card 70 after it has been printed at the end of the transaction. The parts thus printed comprise:

the visual element of the card 72 that surrounds all printed areas (graphics and printing types) in order to identify the service provider operator and the type of the service concerned. For example, the visual element 72 may comprise an indication of the card type in letters 74, the name or the banner of the service provider operator 76, a logotype (in this case a monogram 78 and a symbol 80) and a colour background 82 that may be monochrome or polychrome, and with or without pattern;

the value of the card 84 corresponding to the acknowledged value, expressed to the nearest cent or for a prepaid time to the nearest minute, depending on the configuration;

the serial number of the card 86, so that the operator can identify the transaction and possibly make a technical or commercial check if a problem arises;

the service expiration date 88, when the service is limited by the duration of this prepayments in addition to being limited by the total prepaid amount;

the PIN code 90, so that the telephone service can be used by entering this code before the corresponding number, possibly by pressing on the # key or the star key on the telephone;

the method of use (in this case shown on the back, FIG. 4b); and

an advertising announcement 94, possibly with a graphic 94a The advertiser may be completely independent from the service provider, and simply use the card 70 as a support for his advertising.

In the example, the above-mentioned data are printed on the two faces of the card 70, which requires an appropriate printer. Obviously, the installation could be made technically simpler by printing all these data on one side of the card, and the other side would then remain blank, or it could be pre-printed with a pattern or information that is universally applicable for all the different operators served, for example an advert, a calendar, a graphic, etc.

These printed data can be classified in two categories; data specific to each transaction called “variable data”, and general data, which are invariable for a particular purchased service.

The variable data include the PIN code 90, the card number 96 and the expiration date 88. We have seen that the PIN code is sent to the terminal 4 during the transaction. The same may be true for at least some others of the variable data. In this case, the management centre 2 transmits the number assigned to the card and its expiration date with the PIN code, with reference either to its central database 20, or by getting into communication with the operator 14. However, the card number and the expiration date of the prepayment can be stored internally in the local database 28 of the dispenser 4. The card numbers may correspond simply to an arbitrary number incremented by one unit in each transaction, each dispensing terminal receiving a start number fixed by the operator concerned and retransmitted by the management centre 2. The card number may also be derived from an algorithmic calculation made by the management unit 26 on the PIN code. The expiration date may be determined simply by calculating the validity period sting from the transaction date, this period being fixed in advance by the service provider operator and known at the terminal 4.

General data are stored internally in the local database 28 of the dispensing terminal 4. The local database also includes a set of visual elements 72, one for each type of service and/or service provider operator 14, several presentations of the method of use depending on the provided service, and a set of adverts 94. As described later, the choice of the advert may be fixed in advance (for example depending on a rotation), or it may be adapted depending on the customer's profile.

Thus, during printing, the management unit 26 will selectively extract general data from the local database 28 as a function of the transaction.

After the card is printed (step E18, FIG. 3), the payment ticket is printed (step E20). Before completing the transaction, the dispensing terminal displays a question on the touch screen 30 asking if the customer would like to see the general conditions of sale (step E22). If he would, the printer 40 is activated to print these conditions on a separate sheet (step E24). Different conditions of sale may be assigned for each sold service and/or each independent operator.

The transaction is then concluded by outputting the printed products (step E26), namely the service card(s) 70, the payment ticket and if applicable the sheet containing conditions of sale. These products will be delivered in the reception tray 52.

Finally, the transaction process returns to the viewing step E2 (loop back R4) ready for a new transaction.

We will now describe a second transaction process with reference to FIG. 5, according to which the customer selects the possibility of inserting a message of his choice on the card 70. This process may be an option offered by the system in addition to the transaction process as described with reference to FIG. 3. The common parts of the processes in FIGS. 3 and 5, including the equipment and the different steps, are marked with the same references and will not be described again for reasons of conciseness; only the differences will be described.

In order to implement this process, the customer selects the “customised cards” section on the touch screen 30 during the viewing step E2.

A page is then displayed on this screen, in which one of several model presentations (gift for a special occasion, images, text, etc.) stored in the local database 28 can be selected (step E26).

At least some of the model presentations can be used to insert messages made up by the customer. The process thus continues by the customer inputting the text for the message on the keyboard 54 (step E28). The assembly including the model and the composed message is then integrated into the visual element 72 described above.

The process then continues as for the case in FIG. 3, resulting in the customised card 70 being printed using the colour printer 34, and then this card is delivered.

We will now describe a third transaction process with reference to FIG. 6, that can be used to reload a previously delivered card. The common parts of the processes in FIGS. 3 and 6, for the equipment and the different steps, have the same references, and will not be described again for reasons of conciseness; only the differences will be described.

The process begins at the selection step E2 in which the customer selects the reload card option (for example for a mobile telephone or cabled network).

The customer then selects the card to be reloaded by choosing icons displayed on the touch screen 30 (service provider operator, service type within a range of services, etc.) (step E4).

Once the selection has been made, the customer uses the keyboard 54 to input his account number and/or personal code associated with this card. This may simply be the PIN code already input, and/or the card number. The data thus input are transmitted to the management centre 2 which forwards them, possibly after carrying out a preliminary processing, to the operator concerned 14. This operator queries his data bank 60 and makes a decision about whether or not to accept the reload request.

If an acceptance is sent to the dispensing terminal 4 through the management centre 2, the management centre asks the customer to select the reload value (step E34). This operation is carried out using the methods described above in step E6 in FIG. 3.

Details about the reload (prepayment amount; new expiration date, etc.) are displayed on the touch screen 30.

The process continues with the payment acknowledgement routine (steps E14 to E20). When the bank server 18 has accepted the payment, the management centre 2 issues a confirmation to the operator, so that the operator can permanently record the transaction.

In the case of a non technical card, there is no need to print a new card, particularly if the PIN code remains unchanged.

However, it would be possible to consider printing either a new card 72, even in the case of a reload, or new data (new prepayment amount, new expiration date, possibly the new PIN code) on a simpler support, such as a voucher or the payment ticket.

The dispensing terminals management system 1 can also perform various processes for selling services from smart cards, such as chip cards or magnetic strip cards.

In this case, the colour printer 34 prints the chip cards or magnetic strip cards 70 stored without any visual element and no recorded prepayment value. The transaction then also comprises a step in which the encoder 36 is used to write electronic data onto the chip or the magnetic strip, corresponding to the acquired value.

The terminal 4 may also include the possibility of reloading a previously issued chip card or a magnetic strip card. In this case, an insertion slit (not shown) is necessary so that the card can be inserted such that the encoder 36 can access it to write data about the new prepayment.

The dispensing terminals management system 1 according to the present invention offers possibilities of customised services, particularly concerning the choice of adverts, special offers and loyalty procedures.

The management centre 2 is capable of collecting data about the purchasing habits of each customer and recording these data in its database 20, the customer being identified by information read from his bank card in steps E14 and E16 to validate the order. However, in order to benefit from this information as early as possible in the transaction process, the terminal 4 may be programmed to prompt the customer to insert his bank card, for example in step E2 in which he selects services. The information on this card will be read at this time and different parameters of the current transaction can be modified based on this information, to provide the customised service. A customer number can also be assigned for a first transaction, that the customer can enter on the touch screen 30 or on the keyboard 54 in subsequent transactions, for example at the beginning of each transaction. This identification information (from a bank card or customer code) is thus sent to the management centre 2 so that the management centre can create a file for each customer that will be enriched in each transaction, containing various information such as:

the name and/or number assigned to the bank card, or a customer number, this information forming the customer basic identifier,

statistics about the choice of different services (number and operator(s)) purchased during a given period,

statistics about amounts spent for the different purchased services, particularly so that a global budget for all transactions can be produced,

a history of purchases (frequency, detection of periods in which a particular service was not purchased, etc.), and

the geographic area(s) of the dispensing terminals used by the customer, this information being obtained during exchanges between terminals and the centre 2 during transactions.

All or some of this information will be used to establish the customer profile based on various commercial criteria originating either from the system manager 1, or service provider operators, or advertisers. Several different profiles can then be set up for the same user. Obviously, the extent and confidentiality of this information will comply with laws and legislations in force.

Due to these individualised profiles, the operator of the dispensing terminals 4 management system according to the invention can identify the customer (preferably at the beginning of the transaction) and refer to the database 20 in the management centre 2 concerning the profile built up. These data are then processed by a customisation program so that one or several of the following actions can be ordered:

choice of adverts to be printed on the support 70 (see FIG. 4a) and/or to be scrolled on the touch screen 30. For example, specific adverts (dealers, shops, etc. in the region) may be selected for a customer based in a specific geographic area (according to the history), or adverts for products adapted to the profile of expenses and choices of services made for the customer. The advert to be presented is selected by the management centre 2 as a function of its customer file. Data related to this selection are then transmitted to the automatic dispensing terminal (4) in the form of orders so that the automatic dispensing terminal 4 can select one or several adverts among those stored in the local database 28;

supplementary or new service offers by a service provider operator that the customer usually uses, or offered with expenditure budgets comparable to amounts already spent;

running a loyalty program for the assignment of loyalty points, rebates, gifts, etc. as a function of an existing loyalty account. Loyalty may be managed within the commercial framework of a single operator and in this case the program will operate in the same way as if the operator was taking action directly in the same way as for a conventional sales network, or within a global framework based on sales of all services provided by different independent service provider operators managed by the management centre 2 and the terminals 4. In this case, the loyalty program will be set up at the operator of the network 1 of dispensing terminals according to the invention.

There are several possible ways of increasing loyalty, to provide one-off rebates to be accepted during the current transaction, acquisition of points that can be spent in subsequent transactions, gift offers, possibly with a voucher printed by the terminal to be exchanged at a reception point, increase in the prepaid amount (in time or monetary value) above the chosen value, etc.

According to one embodiment of the invention, a program for collection of information on request can also be managed in order to establish a more precise profile. This program asks a series of questions about the customer during the transaction (marital status, age group, professional situation, lifestyle, etc.), and the customer can answer these questions using the touch screen 30. Interactive games may also be presented during the transaction (psychological test, etc.) in order to better identify the customer. This information is then forwarded to the management centre 2 for processing and to enrich customer files.

The system 1 is also capable of making the terminals 4 operate as Internet access terminals, to provide a service to the general public in return for payment. In this case, the touch screen 30 acts as a monitor for browsing and the alphanumeric keyboard 54 is used to input data. Connection of the terminal to the Internet network is managed at the management centre 2 by the Internet communication module 24. Consequently, a telephone communication channel is open between the terminal 4 and the management centre 2 throughout the browsing session on the Internet. The centre 2 is then used as a relay with an access supplier external to the system.

Payment for this service can be made either by an isolated purchase through the payment terminal 38, or by inputting a PIN code to an Internet access account. In particular, this access mode may be obtained using a card sold through the dispensing terminal 4.

The system also includes remote maintenance and update cycles managed by the management centre 2. Remote maintenance is usually done at night and provides a means of,

checking the state of consumables in each dispensing terminal 4 (printers, cards, paper rolls, etc.);

checking the general condition of dispensing terminals;

refreshing local databases (new visual elements, promotions, conditions of sale, advertising pages to be stored, etc.);

making all necessary requests on the central database 20;

checking and updating the central PIN codes stock (by dialogue between the management centre 2 and the different operators 14); and

checking that the network and the connections are working correctly.

From the above, it will be understood that operation of the system 1 in conformance with this invention is based on two-directional information exchanges between the different service provider operators 14, the management centre 2 and all terminals. Storage locations for this various information may be different from the storage locations described in the application examples, depending on what equipment is installed.

Local storage of various data in the automatic dispensing terminal 4, and particularly information to be displayed on the screen 30 and to be printed on the support, is useful particularly to avoid the need to transmit it from the management centre 2 or directly from the service provider operators 14 during a transaction. This local storage of information thus reduces on-line communication time between the terminal and its management centre or with the service provider operator during a transaction.

However, with the increase in the speed of data transmissions and possibly the reduction in the price of communications, it would be possible that at least some of the above mentioned information could be transmitted from the management centre or from the service provider operator during the transaction, as a function of specific needs, within the framework of the present invention.

The information in question, that may thus be transmitted to the terminal during a transaction (and that will then no longer need to be stored in a database 28 in the dispensing terminals) may be for example at least one of the following:

graphic data related to the visual element to be displayed on the support (for example in the form of print files),

graphic data related to adverts to be displayed on the screen and/or on the support,

general conditions of sale,

the method of use,

the welcome page on the screen,

the different screen pages that are displayed interactively on the screen,

management programs for execution of tasks on the terminal,

customer profiles, histories and management data for offers and loyalty points,

etc.

The automatic dispensing terminal can access this various information in different ways. It may be a specific connection (for example a telephone line) between a terminal and the management centre, the management centre then containing a large amount of interactive intelligence to transmit it to the terminal in real time.

It would also be possible for the management terminal 2 to include or operate with an Internet site specific to the system that manages some or all of the intelligence of transactions (the Internet site operating with the management centre will also be considered as forming part of the management centre). In this case, the automatic dispensing terminals behave like Internet terminals connected to this specific site. The customer of the system then dialogues directly with this site during a transaction, and consequently obtains all required information. The site also manages personal data about profiles, loyalty points, etc., to transmit specific information. It also transmits data to be displayed and to be printed on the support.

Industrial application. The invention provides technical means for purchasing supports through automatic dispensers providing access to different services (telephony, commercial services, loyalty programs, etc.), for example through cards, with local printing of visual elements specific to the service, which gives considerable versatility for different services starting from the same stock of blank supports.

1. System (1) for dispensing services including a management centre (2) connected to at least one automatic dispensing terminal (4) that will issue a printed support (70) that acts as an access means to a service, characterised in that it comprises printing means (32, 34, 50) at the automatic dispensing terminal (4), for producing a local printout of a visual element (72) on a support (70) to identify the service and/or the service provider, through the appearance of the visual element

2. System according to claim 1, characterised in that the said visual element is produced from a suppliers graphic charter, loaded into the said terminal (4) in the form of print data, so that the said printout of the visual element (72) can be made locally.

3. System according to claim 1 or 2, characterised in that the printing means (32,34,50) are programmed so that the visual element (72) can be created locally and have the same appearance as a pre-printed support for a given service.

4. System according to any one of claims 1 to 3, characterised in that the visual element (72) comprises at least one of the following elements printed distinctively:
the banner of the service supplier (76) or the service,
a logotype (78,80), and
a background colour (82) that may be monochrome or polychrome, with or without a pattern.

5. System according to any one of claims 1 to 4, characterised in that the printing means (32, 34, 50) are configured so that a visual element (72) can be created locally on the two faces of the support (70).

6. System according to any one of claims 1 to 5, characterised in that the printing means (32,34,50) are activated to print the visual element (72) during a transaction.

7. System according to any one of claims 1 to 5, characterised in that the graphic data related to each visual element (72) that can be printed locally are stored in advance at the automatic dispensing terminal (4).

8. System according to claim 7, characterised in that the graphic data related to each visual element (72) that can be printed are downloaded in the dispensing terminal (4) from the management centre (2) during an update cycle.

9. System according to any one of claims 1 to 8, characterised in that the graphic data related to the visual element to be printed during a transaction are transmitted to the automatic dispensing terminal (4) from the management centre (2) during this transaction.

10. System according to any one of claims 1 to 9, characterised in that it also comprises printing means (32,34,50) at the automatic dispensing terminal (4), to print variable data on the support (70) during the transaction, including at least one of the following data:
a confidential and individual code (PIN code) providing access to the service purchased during the transaction,
the credit amount acquired for the purchased service (84),
the serial number of the support (86),
the expiration date of the service (88) assigned to the support (70), and
the method of use specific to the purchased service.

11. System according to any one of claims 1 to 10, characterised in that it comprises means to cover the confidential and individual code (PIN code) with an opaque layer that can be removed by scratching.

12. System according to any one of claims 1 to 11, characterised in that it also comprises printing means (32,34,50), at the automatic dispensing terminal (4), to print at least one advert (94,94a) on the support (70) and/or to display it on a screen (30).

13. System according to claim 12, characterised in that data related to printing adverts are stored in the dispensing terminal (4).

14. System according to claim 12, characterised in that the print data necessary for printing an advert during a transaction are transmitted to the automatic dispensing terminal (4) from the management centre at the time of this transaction.

15. System according to any one of claims 1 to 14, characterised in that it is functionally connected through the management centre (2) to several independent service provider operators (14), so that a set of different services of these operators can be provided, so that they can be chosen and sold through the automatic dispensing terminals (4), each service enabling printing of a locally printed specific visual element through printing means (32,34,50) in accordance with a graphic charter of the provider of the services concerned.

16. System according to any one of claims 1 to 15, characterised in that the support (70) is stored in the automatic dispensing terminal (4) in blank form or as a pre-printed form with elements that are valid for all services sold through the said terminal, such that before they are printed, the supports can be used for any of the available different services.

17. System according to any one of claims 1 to 16, characterised in that the automatic dispensing terminal (4) comprises a blank supports loader (70) for each type of support that could be delivered such as a non technical card, a magnetic strip card, a chip card.

18. System according to any one of claims 1 to 17, characterised in that it also comprises means (48, 50) to print general conditions of sale of the different available services.

19. System according to any one of claims 11 to 18, characterised in that the confidential and individual code (PIN code 90) is transmitted to the automatic dispensing terminal (4) through the management centre (2) at the time of the transaction.

20. System according to claim 19, characterised in at the confidential and individual code (PIN code 90) is transmitted to the management centre (2) through the service provider operator (14) concerned during a downloading step during system maintenance cycles.

21. System according to any one of claims 1 to 20, characterised in that each automatic dispensing terminal (4) comprises a screen (30) that interactively displays information about progress with the transaction in relation to a management unit (26) and a local database (28).

22. System according to any one of claims 1 to 21, characterised in that it comprises means (36) to reload a previously opened service access account.

23. System according to any one of claims 1 to 22, characterised in that it comprises means (30,54) to enter and acknowledge an arbitrary prepaid amount to be assigned to an ordered service, this amount being printed (84) on the support (70).

24. System according to any one of claims 1 to 23, characterised in that it comprises means (4,12) to encrypt and decrypt confidential data exchanged between the management centre (2) and each automatic dispensing terminal (4).

25. System according to any one of claims 1 to 24, characterised in that it comprises means to purchase several services of the same type or different types in a single transaction, the purchases possibly being accumulated in memory with acquisitions so far being displayed, each service thus purchased being followed by printing a specific support.

26. System according to any one of claims 1 to 25, characterised in that it comprises means of acquisition of a customer file containing accumulated information about at least one of the following:
the physical location of the automatic dispensing terminal being used,
the choice of the purchased service(s),
amounts spent) and
data provided by the customer through an automatic dispensing terminal (4) during queries made during a transaction,
so as to produce an up to date profile of the customer, the file being accessible at the management centre (2).

27. System according to claim 26, characterised in that adverts can be printed on the support (70) and/or displayed on a screen (30) of the automatic dispensing terminal (4) as a function of the profile drawn up for the customer using the terminal.

28. System according to any one of claims 1 to 27, characterised in that it also manages a customer loyalty program to assign loyalty points, rebates, gifts, etc. as a function of a loyalty account kept open and maintained in the management centre (2).

29. System according to claim 28, characterised in that loyalty may be controlled within the commercial framework of a service provider operator (14).

30. System according to claim 28 or claim 29, characterised in that loyalty is controlled within a commercial framework based on sales from a set of services provided by different independent service provider operators managed by the management centre (2) and the automatic dispensing terminals (4).

31. System according to any one of claims 1 to 30, charaterised in that it comprises means (54) to print a customised message on the support (70).

32. System according to any one of claims 1 to 31, characterised in that it comprises means (26,28,30) of displaying comparative price rate information and/or general conditions of sale for the different available services, to a customer.

33. System according to claim 32, characterised in that the comparative information is stored in a local database (28) in each automatic dispensing terminal (4) by downloading from the management centre (2).

34. System according to any one of claims 1 to 33, characterised in that the automatic dispensing terminal (4) comprises an audio interface (58) in which there is a microphone and a loudspeaker, so that a customer can get in touch with a customer service.

35. System according to any one of claims 1 to 34, characterised in that it comprises interactive display means (30) to display a welcome page controlled directly from the management centre (2), so that the contents of the menu can be modified from a remote location.

36. System according to any one of claims 1 to 35, characterised in that the automatic dispensing terminal (4) comprises means of writing data (36), so that electronic data about a prepayment can be written into a smart card during a transaction to purchase a card or to reload a card.

37. System according to claim 36, characterised in that the support is in the form of a smart card, and particularly a chip card and/or a magnetic strip card, a prepayment being memorised on the card at the time that the data (36) are written.

38. System according to any one of claims 1 to 37, charaterised in that the support is in the form of a non technical card (70).

39. System according to any one of claims 1 to 38, characterised in that at least one of the available services may relate to the sale of cards for use in telephony on the fixed or a mobile network.

40. System according to any one of claims 1 to 39, characterised in that at least some automatic dispensing terminals (4) may also be operational as access terminals providing access for the general public to the Internet in return for prepayment, the said terminal using a display screen (30) and a keyboard (54), and a modem (4) connected to the terminal and to an Internet access supplier through the management centre (2).

41. Automatic dispensing terminal (4) specifically adapted to the system according to any one of the previous claims, characterised in that it comprises printing means (32, 34, 50) to create a local printout of a visual element (72) on the support (70) so that the service and/or the service provider can be identified through the appearance of the visual element.

42. Method for dispensing services based on a management centre (2) connected to at least one automatic dispensing terminal (4) that will output a printed support (70) that forms a means of accessing a service, characterised in that a visual element (72) is printed on the support (70) in the automatic dispenser (4), so that the service and/or service provider can be identified by the appearance of this visual element.

43. Method according to claim 42, characterised in that the visual element (72) will be printed at the time of a transaction.

44. Method according to claim 42 or claim 43, characterised in that the said visual element is printed from a graphic charter of the supplier, loaded in the form of printing data in the said terminal (4), to create a local printout of the visual element (72).

45. Method according to any one of claims 42 to 44, characterised in that the visual element (72) comprises at least one of the following elements printed distinctively:
the banner of the service supplier (76) or the service,
a logotype (78,80), and
a background colour (82) that may be monochrome or polychrome, with or without a pattern.

46. Method according to any one of claims 42 to 45, characterised in that the graphic data related to each visual element (72) to be printed are stored in advance at the automatic dispensing terminal (4).

47. Method according to claim 46, characterised in that the graphic data related to each visual element (72) that can be printed are downloaded in the dispensing terminal (4) from the management centre (2) during update cycles.

48. Method according to any one of claims 42 to 47, characterised in that the graphic data related to the visual element to be printed during a transaction are transmitted to the automatic dispensing terminal (4) from the management centre (2) at the time of this transaction.

49. Method according to any one of claims 42 to 48, characterised in that the support (70) is stored in the automatic dispensing terminal (4), in blank form or as a preprinted form with elements that are valid for all services sold through the said terminal, such that before they are printed, the supports can be used for any of the available different services.
